(19) United States
(12) Patent Application Publication
(10) Pub. No.: US 2003/0184104 A1
(43) Pub. Date: Oct. 2, 2003

(54) Foldable shovel

(75) Inventor: Qiu Jian Ping, Hangzhou (CN)

Correspondence Address: WILLIAM COLLARD, COLLARD & ROE, P.C., 1077 NORTHERN BOULEVARD, ROSLYN, NY, 11576, US

(73) Assignee: Great Neck Saw Manufacturers, Inc.

(21) Appl. No.: 10/097,077

(22) Filed: Mar. 14, 2002

(51) Int. Cl. A01B 1/22

(52) U.S. Cl. 294/57

(57) ABSTRACT

A foldable shovel having a plurality of elements telescopically mounted together. The elements include a blade, a hand grip and an intermediate section with the intermediate section telescopically mounted to the blade and the hand grip. Openings in the blade, section and hand grip and a locking clip for locking the intermediate section to the blade and to the hand grip. The locking clip is a resilient clip having a button removably extending into the openings in order to hold the intermediate section to the blade and to the hand grip.

### BACKGROUND

The present invention relates to shovels and more particularly to foldable shovels which can be disassembled for storage, shipping or length adjustment and which can be easily re-assembled.

Foldable shovels have been in use for a number of years. In general they comprise blades, handles and hand grips which can be disassembled and reassembled from each other for storage, shipping or length adjustment. Known foldable shovels are complex to assemble and disassemble, sometimes require special tools and are expensive and complicated to manufacture and maintain.

### OBJECTS

The present invention overcomes these drawbacks and has for one of its objects the provision of an improved foldable shovel which may be easily assembled and disassembled.

Another object of the present invention is the provision of an improved foldable shovel which can be easily assembled and disassembled without the use of special tools.

Another object of the present invention is an improved foldable shovel in which the length of the tool may be easily adjusted.

Another object of the present invention is the provision of an improved foldable shovel which is simple to use and inexpensive and simple to manufacture and maintain.

Other and further objects of the invention will be obvious upon an understanding of the illustrative embodiment about to be described, or will be indicated in the appended claims and various advantages not referred to herein will occur to one skilled in the art upon employment of the invention in practice

### DRAWINGS

A preferred embodiment of the invention has been chosen for purposes of illustration and description and is shown in the accompanying drawings forming a part of the specification wherein:

FIG. 1 is an exploded perspective view showing the foldable shovel of the present invention.

FIG. 2 is a top plan view of the shovel.

FIG. 3 is a side plan view of the shovel.

FIG. 4 is a sectional view taken above line 4-4 of FIG. 3.

FIG. 4A is an exploded sectional view similar to FIG. 4 showing the position of some of the parts when the shovel is disassembled.

FIG. 5 is a sectional view taken along line 5-5 of FIG. 2.

FIG. 6 is a sectional view taken along line 6-6 of FIG. 3.

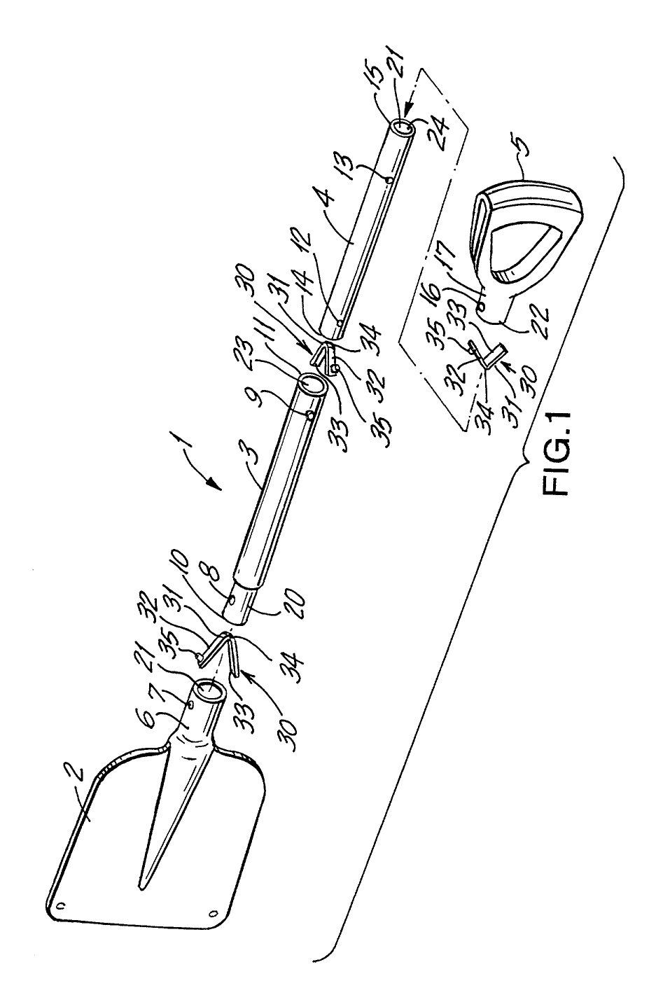

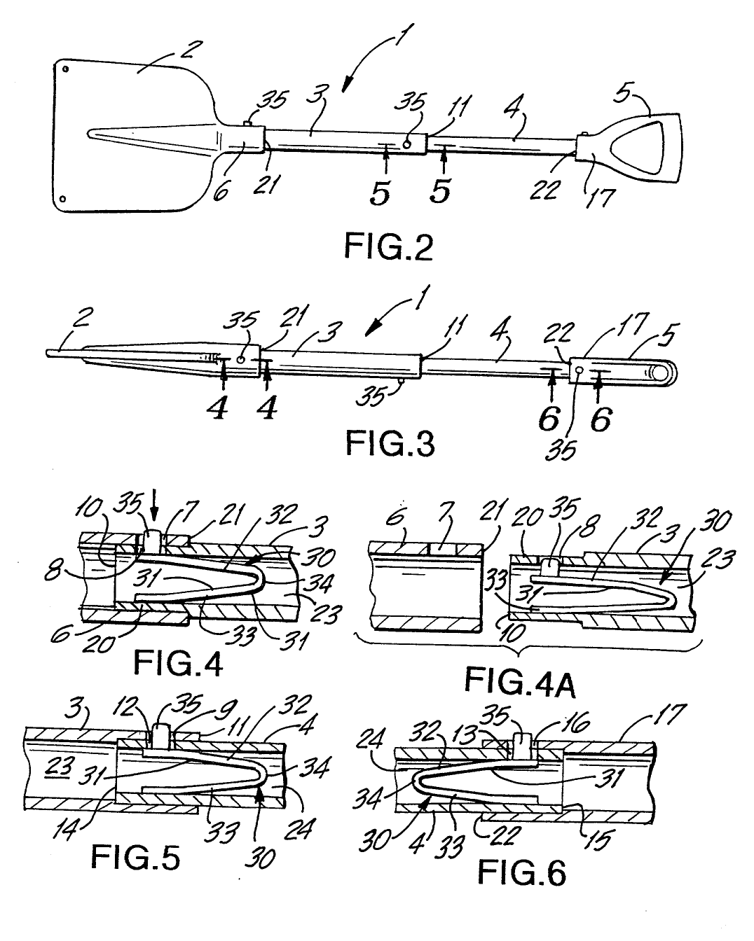

### DESCRIPTION

Referring to the drawings, the foldable shovel 1 of the present invention comprises a blade 2, handle sections 3 and 4 and a hand grip 5. The blade 2 has a stem 6 extending therefrom and the hand grip 5 has a stem 17 extending therefrom. The stem 6 of the blade 2 has an opening 7 therein; section 3 has openings 8 and 9 therein adjacent the ends 10 and 11, respectively; section 4 has openings 12 and 13 therein adjacent the ends 14 and 15, respectively; and stem 17 of the hand grip 5 has an opening 16 therein. The section 3 may have a reduced diameter portion 20 adjacent end 10 so that it may telescope into the end 21 in the blade stem 6. The section 4 may be made entirely of reduced diameter so that it may telescope into the end 11 of the section 3 and the end 22 of the hand grip stem 17. However, it will be understood that the diameters of the various parts may be changed so long as certain parts of the shovel may telescope over and/or into other parts. It will also be seen that the length of the shovel 1 can be shortened or lengthened depending on the number of sections 3 and 4 used and that more or less sections 3 and/or 4 may be used without departing from the invention.

Improved holding means 30 are provided to removably hold the various parts 2, 3, 4 and 5 of the shovel 1 together and to permit easy assembling and disassembling thereof The holding means 30 comprises a resilient lock clip 31 having a pair of opposed legs 32 and 33 which are formed by bending a single strip of resilient material to form opposed legs 32 and 33 into a V having apex 34. The legs 32-33 can be pressed together and when released the resiliency of the clip 31 will cause them to spring back to their original position. The clips 31 are mounted within the inner surface 23 of the section 3 reduced portion 20 adjacent end 10 and on the inner surface 24 of the section 4 adjacent ends 14 and 21. The two legs 32-33 are sufficiently spread apart and biased outwardly so that they will bear against and be held frictionally within the inner surfaces 23 and 24 of the sections 3 and 4. One leg 32 has a push button 35 which is adapted to be pressed in to compress leg 32 relative to the leg 33 and which is adapted to extend through the openings 7, 8, 9, 12, 13 and 16 to lock the various parts together. The various parts are held in place by the frictional force exerted by the legs 32-33 of the clips 31 on the inner surfaces of the sections 3 and 4 and the push buttons 35 inserted into the various openings 7, 8, 9, 12, 13 and 16. If desired, the leg 33 of some or all of the clips 31 may be permanently or removably attached to the inner surface of any one or more of the sections 3 or 4 without departing from the invention. In addition, any of the clips 31 may be completely removed from one shovel or section thereof and used within another shovel or section.

In the shovel 1 shown in the drawings, a clip 31 is positioned in the end 10 of section 3 and has push button 35 extending through its opening 8. The reduced portion 20 of section 3 is then telescopically inserted within the open end 21 of the blade stem 6 and push button 35 is manually depressed so that the legs 32-33 of the clip 31 are compressed and the push button 35 slides within and along the inner surface of the blade stem 6 until it reaches the opening 7. At this point, the natural resiliency of the clip 31 snaps the leg 32 outwardly so that the push button 35 moves into the opening 7 to hold the blade 2 and section 3 together. In order to disassemble the two it is merely necessary for the push button 35 to be depressed until it moves out of the opening 7 in the blade stem 6 so that the reduced portion 20 of the section 3 can be telescopically moved out of blade stem 6.

In a similar manner, a clip 31 is positioned within section 4 adjacent its end 14. Push button 35 extends through the opening 12 where the resilient clip 31 is held in place at that point. The push button 35 is pressed down to compress the legs 32-33 of the clip 31. Section 4 is then telescopically inserted into section 3 and the push button 35 will slide along the inner surface 23 of section 3 until it reaches the opening 9. At this point, the legs 32-33 of the clip 31 snap automatically and push button 35 moves into the opening 9 to hold the two sections 3 and 4 together. When it is desired to disassemble the two sections, it is merely necessary to press the push button 35 down until it is out of the opening 9 after which the section 4 can be telescopically moved out of the section 3.

Likewise, a clip 31 is positioned within the section 4 adjacent the end 15. In this position, the push button 35 extends through the opening 13 and the clip 31 is held in place at this point. The push button 35 of clip 31 is pressed in and the end 15 is telescopically inserted within the stem 17 of the hand grip 5. The push button 35 moves along the inner surface of the hand grip 17 until it reaches the opening 16. At this point, the legs 32-33 will spread apart to move the push button 35 into the opening 16. This will hold the hand grip 5 and the section 4 together. When it is desired to remove the hand grip 5 from section 4 it is merely necessary to depress the button 35 until it is out of the opening 16 at which point the section 4 can be telescopically removed from the hand grip stem 17.

It will thus be seen that the present invention provides an improved foldable shovel which may be easily assembled and disassembled, which can be easily assembled and disassembled without the use of special tools, in which the length of the tool may be easily adjusted, and which is simple to use and inexpensive and simple to manufacture and maintain.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A foldable shovel comprises a plurality of elements telescopically mounted together and said elements comprise a blade, a hand grip and an intermediate section, said intermediate section being telescopically mounted to said blade and to said hand grip, openings in said blade, section and hang grip, locking means for locking the intermediate section to the blade and to the hand grip, said locking means comprises a resilient clip having a button removably extending into said openings in order to hold the intermediate section to the blade and to the hand grip.

2. A foldable shovel as set forth in claim 1, wherein said clip comprises a pair of legs and said button extending from one of said legs.

3. A foldable shovel as set forth in claim 2, wherein said legs are opposed to each other and wherein said button faces away from the two legs.

4. A foldable shovel as set forth in claim 3, wherein said clip is comprised of one piece, and wherein said legs are formed by bending said one piece.

5. A foldable shovel as set forth in claim 4, wherein said clip has an apex where the two legs meet.

6. A foldable shovel as set forth in claim 5, wherein said clip is V-shaped.

7. A foldable shovel as set forth in claim 6, wherein said clip is mounted in at least one of said elements.

8. A foldable shovel as set forth in claim 7, wherein said clip is mounted within a first element with its button extending through the opening in said element and wherein said button extends into the opening in the other element which is telescopically mounted on the first element.

9. A foldable shovel as set forth in claim 8, wherein said blade has a stem having said opening therein.

10. A foldable shovel as set forth in claim 9, wherein said hand grip has a stem having said opening therein.

11. A foldable shovel as set forth in claim 10, wherein said h and grip is mounted in said intermediate section and has its button extending into the opening of said intermediate section and into the opening in said stem.

12. A foldable shovel as set forth in claim 11, wherein at least two intermediate sections are provided between said blade and said hand grip

13. A foldable shovel as set forth in claim 12, wherein said intermediate portions are telescopically mounted to each other.

14. A foldable shovel as set forth in claim 13, wherein said clip is mounted within one of said intermediate sections and its button extends through the openings in both intermediate sections.

15. A foldable shovel as set forth in claim 14, wherein said clip is frictionally held within said elements with the force of legs pressing against the inside of said elements.

16. A foldable shovel as set forth in claim 15, wherein one of the intermediate sections is telescopically mounted to the stem of said blade and wherein a locking clip is mounted within the intermediate section with its button extending into the openings in the intermediate section and the stem of the blade.

17. A foldable shovel as set forth in claim 16, wherein one of the other of said intermediate sections has a clip mounted therein and has its button extending through the openings in intermediate section and the stem of the hand grip.

18. A foldable shovel as set forth in claim 17, wherein a resilient clip having a pair of legs and a button extending from one of said legs.

19. A clip as set forth in claim 18 wherein said legs are opposed to each other and wherein said butt on faces away from the two legs.

20. A clip as set forth in claim 19 wherein said clip is comprised of one piece and wherein said legs are formed by bending said one piece and wherein said clip has an apex where the two legs meet.

21. A chip as set forth in claim 20, wherein said clip is V-shaped.
